(19) United States
(12) Patent Application Publication
(10) Pub. No.: US 2011/0080467 A1
(43) Pub. Date: Apr. 7, 2011

(54) A METHOD OF GENERATING A PROFILE OF THE PATH TAKEN BY AN OBJECT TRAVELLING OVER A 3-DIMENSIONAL SURFACE

(76) Inventor: Damien Daly, London (GB)

(21) Appl. No.: 12/921,461

(22) PCT Filed: Mar. 13, 2009
(86) PCT No.: PCT/GB2009/000698

§ 371 Date: Dec. 7, 2010

(30) Foreign Application Priority Data
Mar. 14, 2008 (GB) 0804798.7

(51) Int. Cl. H04N 13/00; G06K 9/00

(52) U.S. Cl. 348/43; 382/103; 348/E13.001

(57) ABSTRACT

The subject matter disclosed herein provides methods and apparatus, including computer program products and computing-system implemented methods, for providing two-dimensional path profiles of three-dimensional spaces or surfaces. In one aspect, there is provided a method. The method may capture a moving image including one or more golf strokes. The correlation process may generate information defining the path taken by the object over a space or surface as defined by a map. Related apparatus, systems, methods, and articles are also described.

### FIELD

The present invention relates to a method of generating a 2-dimensional profile of the path taken by an object travelling over a 3-dimensional surface at a location. The invention has particular reference to a method for profiling the path taken by a ball such, for example, as a golf ball when moving over the surface, such as when a golf ball is putted on a green. The invention also embraces apparatus for generating such a 2-dimensional profile.

### BACKGROUND

Golfers and golf watchers are generally interested in optimising their techniques. This interest is manifested in studying information related to the golf ball's trajectory information and velocity. In particular, the path that a ball takes on its way to the hole is a point of major interest for players and watchers alike. There is always a desire to improve one's golf game. This is particularly true of major competitions where the target holes are moved continually to provide the most challenging circumstances for approach shots. In these instances, the golfer's ability to “read” the profile of the ground and the contours and play accordingly are paramount. The skill of the golfer is in hitting the ball so that its travel makes use of the dips and bumps of the surface, guiding the ball to the hole.

### SUMMARY

According to one aspect of the present invention, there is provided a method of generating a 2-dimensional profile of the path taken by an object travelling over a 3-dimensional surface at a location, said method comprising the steps of:

(i) obtaining a digitised map of said location, said map comprising contour information defining contours of said surface;

(ii) capturing a moving image of said object as it travels over the surface;

(iii) obtaining information allowing the captured image to be correlated with said map and thereafter performing such correlation;

(iv) using said correlation, processing said captured moving image to generate information defining the path taken by the object over said surface as defined by the map; and

(v) from said contour information determining the profile of said path.

By “map” it will be understood that what is meant is the data defining the contours of said surface; it is not necessary for the map to be represented in a graphical manner, although such graphical representation certainly also falls within the ambit of the present invention. In some instances it will be appreciated that the shape of the surface may change over time. For instance a putting green may be remodelled from time to time. In such case the invention comprehends generating a 2-dimensional profile of the path taken by an object travelling over a 3-dimensional surface at a location at a given point in time. In such case, the digitised map defines the contours of the surface at said point in time.

In some embodiments, said captured image may be processed to generate information for allowing the image to be correlated with the map. For example, said information for allowing the image to be correlated with the map may comprise information defining the surface. By “correlating” the image with the map is meant aligning the captured image with the obtained map, so that each point on the surface as captured in the moving image may be mapped to a corresponding respective point on the map, thereby to allow the path taken by the object to be plotted on the map.

Further, in some embodiments, positional information may be obtained that defines the position at which the moving image is captured. Such positional information may be used to acquire the digitised map of the location. Said positional information may comprise GPS data or comparable positional technology identifying the geographical location at which the moving image is captured.

Said captured moving image may comprise time information defining the relative or absolute time at which each moment or frame of the moving image is captured. In some embodiments, said captured moving image may comprise a frame rate of the kind known to those skilled in the art.

In some embodiments of the invention, information defining the change of position of the object on the surface over time may be obtained. Such information may be derived from said time information and said information defining the path taken by the object over the surface as defined by the map. Said information defining the change of position of the object may comprise the distance travelled by the object from a predetermined datum at any given instant in time. Said information may be processed, e.g., by differentiation, to obtain information defining the instantaneous velocity of the object.

Further, said information defining the instantaneous velocity of the object may be processed, e.g., by differentiation to obtain information defining the instantaneous acceleration (or ‘drive’) of the objection. Thus, in some embodiments, said information may comprise the acceleration of the object. This information may be calculated by obtaining positioning information of the object at equidistant time intervals.

In another aspect of the present invention therefore there is provided apparatus for generating a 2-dimensional profile of the path taken by an object travelling over a 3-dimensional surface at a location, said apparatus comprising:

(i) an image capturing device for capturing a moving image of said object as it travels over said surface;

(ii) a position recording device for recording the geographical position of the location at which said moving image is captured;

(iii) a data acquiring device for obtaining a digitised map of said location based on said geographical position, said map comprising contour information defining contours of said surface; and

(iv) information processing means for processing said captured moving image to generate image information for allowing the image to be correlated with said map, using said image information to correlate said captured moving image with said map, processing said captured moving image using said correlation to generate information defining the path taken by the object over said surface as defined by the map and determining the profile of said path from said contour information.

As mentioned above, where the shape of the surface alters with time, the digitised map of the location comprises contour information defining the contours of the surface at the relevant time.

In one embodiment, the moving image may be captured using a hand-held device incorporating a camera or other moving image recording device and a global navigation satellite system receiver such, for example, as a GPS device, or another geo-spatial positioning device, which is able to record the geographic position at which the moving image is captured by said handheld device.

Alternatively, the information for allowing the image to be correlated with the map may comprise information defining the position and orientation relative to the surface at which the moving image is captured. For example, where the image is captured using a stationary camera, or a plurality of such cameras, then the spatial position of such cameras relative to the surface may be recorded. Said spatial position may be defined by the latitudinal, longitudinal and altitudinal coordinates, and orientation, of said one or more cameras relative to the surface.

Thus, in yet another aspect of the invention there is provided apparatus for generating a 2-dimensional profile of the path taken by an object travelling over a 3-dimensional surface at a location, said apparatus comprising:

(i) an image capturing device for capturing a moving image of said object as it travels over said surface;

(ii) a data acquiring device for obtaining a digitised map of said location, said map comprising contour information defining contours of said surface, and information for allowing the captured image to be correlated with said map; and

(iii) information processing means for correlating said captured moving image with said map, processing said captured moving image using said correlation to generate information defining the path taken by the object over said surface as defined by the map and determining the profile of said path from said contour information.

Said information for allowing the captured image to be correlated with the map may therefore include the position and orientation of the image capturing device relative to said surface.

In some embodiments said information processing means may comprise a processor or at least one processor. However, by ‘information processing means’ is generally meant any suitable means for processing data electronically, and is not necessarily confined to the use of a single processor or machine or to a single location. For instance said information processing means may be provided as a service over the Internet (“Cloud Computing”) or any other computer network.

In some embodiments, the captured moving image may comprise recorded time information defining the absolute or relative time at which each moment or frame of the moving image is captured. Such recorded time information is well known to those skilled in the art. Based on such time information and the information defining the path taken by the object over the surface as defined by the map, said processor or other information processing means may be configured for generating information defining the change of position of the object with time.

In some embodiments, said processor or other information processing means may be configured to process such information to determine the instantaneous velocity and/or acceleration (‘drive’) of the object, e.g., by differentiating the information defining the path taken by the object over the surface (i.e., distance travelled) with respect to the time information.

Suitably, said surface may comprise a putting green, and said object may comprise a golf ball. It will be appreciated, however, that the present invention may be applied to any situation where it is desired to plot the 2-dimensional profile of an object, such as a ball, moving over a 3-dimensional surface, which 3-dimensional surface is preferably non-planar. For instance, the invention may also be applied to plotting the 2-dimensional profile of a bowling ball moving over a profiled ‘Crown Green’ bowling green.

Thus, where the movement of a golf or other ball over the surface, for example a green or other playing surface is captured using one or more stationary cameras, for example where a golf tournament is being televised, the position and orientation of the one or more cameras relative to the green may be used to correlate the image acquired by the one or more cameras with a digitised map of the green or other surface.

Alternatively, where movement of the ball over the surface is captured using a video camera of the kind that is incorporated into a hand-held device such, for example, as a mobile telephone having such video-camera functionality, the general geo-spatial position of the location may be determined using a GPS device or other global navigation satellite system receiver integrated in the handheld device, and the captured image processed to allow it to be correlated with a map obtained on the basis of said geo-spatial position.

In some implementations, the subject matter described herein provides the advantage of building knowledge of particular golf courses and greens; building knowledge and appreciation of the techniques and skills of leading players; and enabling an appreciation of particular approaches and green shots.

In yet another aspect of the present invention there is provided a computing system-implemented method of generating a 2-dimensional profile of a path over a 3-dimensional surface taken by an object at a location, said method comprising:

correlating digital map information of the location with moving image information captured of the object in a path over the 3-dimensional surface of the location to generate a correlation between the object and the surface, the digital map information including contour information defining a contour of the 3-dimensional surface;

generating path information of the path over the 3-dimensional surface taken by the object based on the correlation; and determining the 2-dimensional profile of the path over the 3-dimensional surface taken by the object based on the path information and the contour information.

Said computing system-implemented method may in some embodiments be implemented on a single computer. Alternatively the computing resources that constitute the computing system may be distributed over a network, e.g., the Internet. For example, in some embodiments, the method may be implemented using at least some computing services provided over the Internet as “Cloud Computing”.

In yet another aspect of the present invention there is provided a computer program product, embodied in instruction code stored on a machine-readable medium, for generating a 2-dimensional profile of a path over a 3-dimensional surface taken by an object at a location, the instruction code including instructions that cause a computing system to:

correlate digital map information of the location with moving image information captured of the object in a path over the surface of the location to generate a correlation between the object and the surface, the digital map information including contour information defining a contour of the 3-dimensional surface;

generate path information of the path over the 3-dimensional surface taken by the object based on the correlation; and

determine the 2-dimensional profile of the path over the 3-dimensional surface taken by the object based on the path information and the contour information.

In yet another aspect of the present invention there is provided a computing system for generating a 2-dimensional profile of a path over a 3-dimensional surface taken by an object at a location, the computing system comprising:

information processing means adapted to:
correlate digital map information of the location with moving image information captured of the object in a path over the surface of the location to generate a correlation between the object and the surface, the digital map information including contour information defining a contour of the 3-dimensional surface;
generate path information of the path over the 3-dimensional surface taken by the object based on the correlation; and
determine the 2-dimensional profile of the path over the 3-dimensional surface taken by the object based on the path information and the contour information; and

a display to generate and output a display of the 2-dimensional profile of the path over the 3-dimensional surface.

As mentioned above, said information processing technique means may comprise one or more computer processors.

In yet another aspect of the present invention there is provided a computer-system implemented method of generating a 2-dimensional profile of a path over a 3-dimensional surface taken by an object at a location, the method comprising:

receiving in a computing system digital map information of the location, the digital map information including contour information defining a contour of the 3-dimensional surface;

receiving in the computing system moving image information captured of the object in a path over the surface of the location;

correlating, using the computing system, the digital map information with the moving image information to generate a correlation between the object and the surface;

generating, using the computing system, path information of the path over the 3-dimensional surface taken by the object based on the correlation; and

determining, using the computing system, the 2-dimensional profile of the path over the 3-dimensional surface taken by the object based on the path information and the contour information.

In yet another aspect of the present invention there is provided a computer-system implemented method comprising:

correlating digital map information of the location received from a data-acquiring device with moving image information captured by an image-capturing device of the object in a path over the 3-dimensional surface of the location to generate a correlation between the object and the surface, the digital map information including contour information defining a contour of the 3-dimensional surface;

generating path information of the path over the 3-dimensional surface taken by the object based on the correlation; and

determining the 2-dimensional profile of the path over the 3-dimensional surface taken by the object based on the path information and the contour information.

The above description sets forth the more important features of the present invention in order that the detailed description thereof that follows may be understood, and in order that the present contributions to the art may be better appreciated. Other objects and features of the present invention will become apparent from the following detailed description considered in conjunction with the accompanying drawings. It is to be understood, however, that the drawings are designed solely for the purposes of illustration and not as a definition of the limits of the invention, for which reference should be made to the appended claims.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed embodiments. In the drawings,

FIG. 1 depicts in schematic a method of generating a two-dimensional profile of the path taken by an object;

FIG. 2 depicts a block diagram of the present invention; and

FIG. 3 depicts graphically a possible correlation profile of a captured image of a three-dimensional surface of the present invention.

FIG. 4 depicts graphically a plan view of the path taken by an object over a surface.

FIG. 5 depicts a possible example of information displayed graphically in accordance with the invention.

Like reference symbols in the various drawings indicate like elements.

### DETAILED DESCRIPTION

The implementations set forth in the following description do not represent all implementations consistent with the subject matter described herein. Instead, they are merely some examples consistent with certain aspects related to the described subject matter. It is also to be understood that the terminology used herein is for the purpose of describing particular implementations only, and is not intended to be limiting.

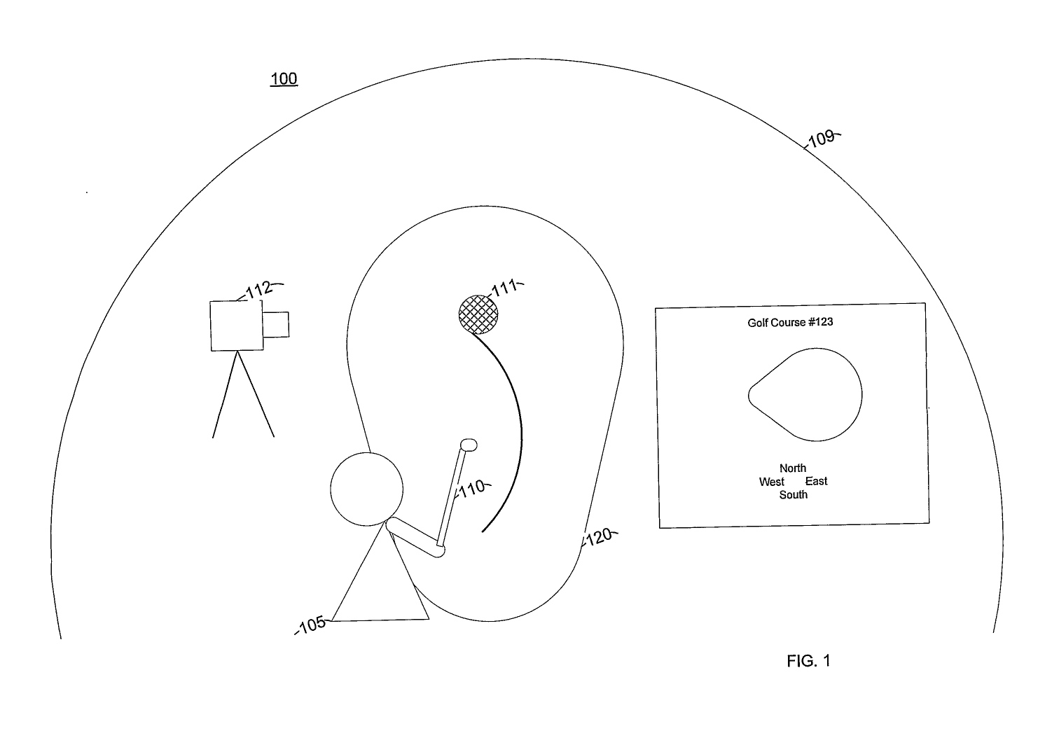

FIG. 1 depicts schematically a method of generating a two-dimensional profile of a path taken by an object 111 moving over a surface 120 such as, for example, a golf ball moving on a putting green. FIG. 1 also depicts a digitised map 180 of the surface 120. The digitised map 180 comprises contour information defining contours of the surface 120. FIG. 1 also depicts the object 111 as it travels over said surface 120. Finally, FIG. 1 depicts information defined by the path taken by moving object 111.

Although FIG. 1 depicts a digitised map 180 at surface 120, said digitised map 180 may exist at other locations such as at a remote user location, at a computer server, at a database, and the like.

In some implementations, it is preferred that the capturing of a moving image be with a digital camera or a similar video-recording device. Furthermore, it is preferred that the capturing of a moving image over the surface be continuous. For example, capturing of this implementation may be with a digital camera worn by golfer 105.

Advantageously, the camera or other video-recording device is capable of recording the absolute or relative time of capture of each frame or moment of the moving image. For instance, the captured moving image may comprise a time code of the kind well known to those skilled in the art. This allows the absolute or relative time that the object 111 is disposed at each position to be recorded.

The moving image may be captured by or one or more cameras 112 that are fixed relative to the surface 120 at least during capture of the moving image; the position(s) and orientation(s) of such one or more cameras 112 relative to the surface 120 may be recorded to facilitate correlation of the moving image with the digitised map 180. Thus, the geo-spatial position(s) of the one or more cameras may be determined, for example using a GPS or another purposively similar global navigation satellite system receiver at the position(s) of or incorporated in the camera(s).

Alternatively, the capturing of the moving image can be obtained by a mobile telephone equipped with video recording capabilities. Thus, for example, a third party may record the moving image with their mobile telephone's video recording device.

In some implementations, the information for allowing the image to be correlated with the map may include surface data such as inclines and valleys of the surface. For example, a putting green normally has slight inclines such that the surface is not completely flat, representing a challenge to the golfer. Thus, in such implementations, the captured moving image may be processed to identify such characteristic features of the surface to enable the moving image of the surface to be correlated with the digitised map, e.g., by using a processor to align such characteristic features in the captured moving image with the same characteristic features of the surface as defined by the map. The correct map may be identified using GPS data captured by a receiver positioned at the surface.

Alternatively, in some implementations, the information for allowing the image to be correlated with the map may include information defining the position and orientation of the moving object relative to the surface. In some implementations, successive points at which the moving object has travelled may be obtained, for example using a suitable global navigation satellite system. These points may be used to obtain the proper digitised map of the location and areas travelled. For example, latitudinal, longitudinal and altitudinal coordinates may be obtained for successive positions of the moving object.

In some implementations, it is preferred that the correlation of the moving image and the map may be displayed as a path profile. A path profile is a two-dimensional diagram or schematic showing the path taken by the object over the surface, including latitudinal, longitudinal, and altitudinal plots.

In some implementations, it is preferred that the moving object 111 is a golf ball and the surface 120 is a putting green.

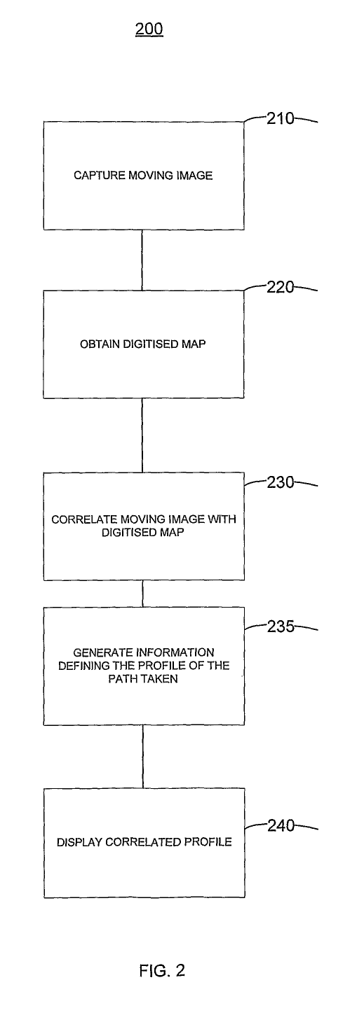

FIG. 2 shows a block diagram of the correlation of a captured image of the present invention and a digitised map.

At 210, a moving image of an object such as a golf ball 111 on putting green 120 or other playing surface is captured. In some implementations, the moving image capture is of images of a golf ball on a putting green. For example, a user, such as “Tiger,” may be golfing on the putting green. A moving image capture may be generated of the golf shot that Tiger made from point X to point Y.

At 220, after capturing of said moving image a digitised map 180 of the location of the putting green is obtained. The digitised map may include one or more of the following: a map of the entire putting green 120; and contour information of the surface of the putting green 120. As mentioned above, in some implementations, the geo-spatial position and orientation of the video camera(s) used to capture the moving image relative to the putting green 120 is recorded, to allow the captured moving image to be correlated with a digitised map of the surface. Alternatively, the moving image may be analysed using a processor to identify one or more characteristic features of the surface which may then be aligned with the same features in the digitised map of the surface to allow the captured moving image to be correlated with the map. It will be appreciated that the digitised map does not have to be in graphical form, but must comprise data defining the 3-dimensional profile and geo-spatial position of the surface. In cases where the moving image is analysed to identify characteristic features to facilitate correlation of the moving image with the map, the correct map to be compared with the moving image may be determined by recording the geo-spatial position at which the moving image is recorded by means of a GPS or similar receiver positioned at the location of the video camera or incorporated therein.

At 230, the moving image capture is correlated with the obtained digitised map 180 such that each point on the image of the surface as captured is mapped to a corresponding point on said digitised map. In this way, the image of the path taken by the object 111 moving over the surface 120 can be mapped onto a corresponding path on the digitised map.

At 235, correlation processing of the moving image and the digitised map 180 thus generates information defining the profile of the path taken by the golf ball 111 over the surface of putting green 120 captured at 210. The correlation process combines moving image data and information from the digitised map 180 to generate a profile 240 of the path taken by the golf ball 111. The correlated profile 240 may be generated for display at putting green 120.

In some implementations, correlated profile 240 may be displayed at other locations such as at a remote user location, at a computer server, at a database, and the like.

Table 1 below depicts an example of numeric data for a profile diagram

TABLE 1
Sample data for correlated profile.

| Time | Coordinates of golf ball in X, Y, and Z | Digital image file |
|---|---|---|
| 45 s | 35, 120, 3 | X883hgks3.jpg |
| 46 s | 33, 125, 5 | X883hgks8.jpg |
| 47 s | 31, 130, 6 | X883hgks6.jpg |
| 48 s | 30, 135, 7 | X883hgus10.jpg |
| 49 s | 33, 140, 9 | X883hgks4.jpg |
| 50 s | 34, 145, 8 | X883hgks9.jpg |
| 51 s | 37, 150, 7 | X883hgus13.jpg |
| 52 s | 38, 155, 6 | X883hgus14.jpg |
| 53 s | 39, 157, 2 | X883hgus22.jpg |
| 54 s | 42, 158, 1 | X883hgeus1.jpg |
| 55 s | 43, 159, 2 | X883hgeus4.jpg |

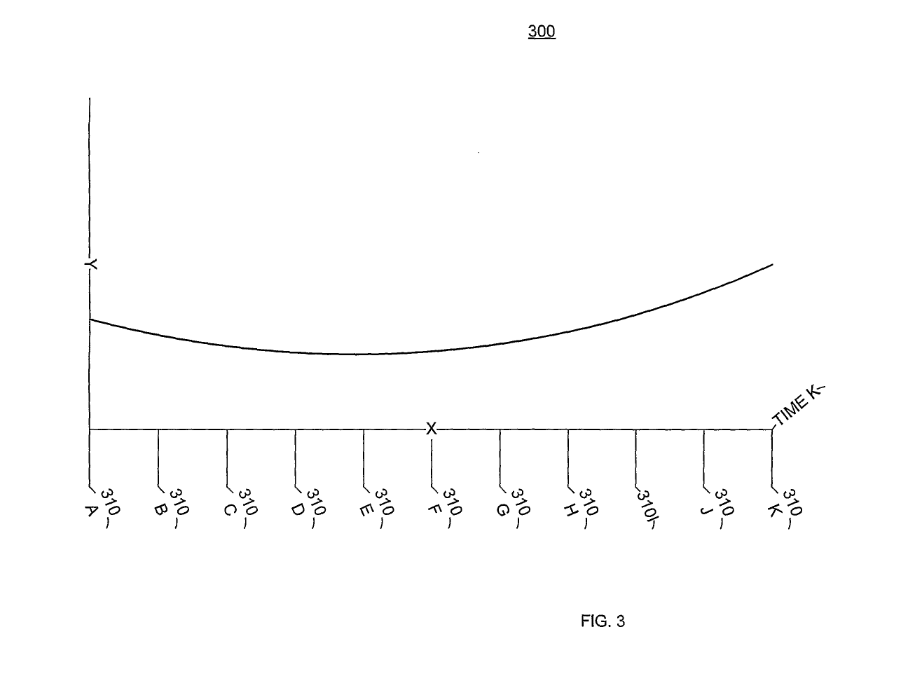

FIG. 3 depicts graphically an exemplary correlation profile of a captured image of a three-dimensional surface of the present invention. Typically, said correlation profile may be displayed visually on a suitable monitor, for example a television screen. In some embodiments, such correlation profile may be superimposed upon video footage of the moving ball, for example, but not necessarily, replay of the captured moving image.

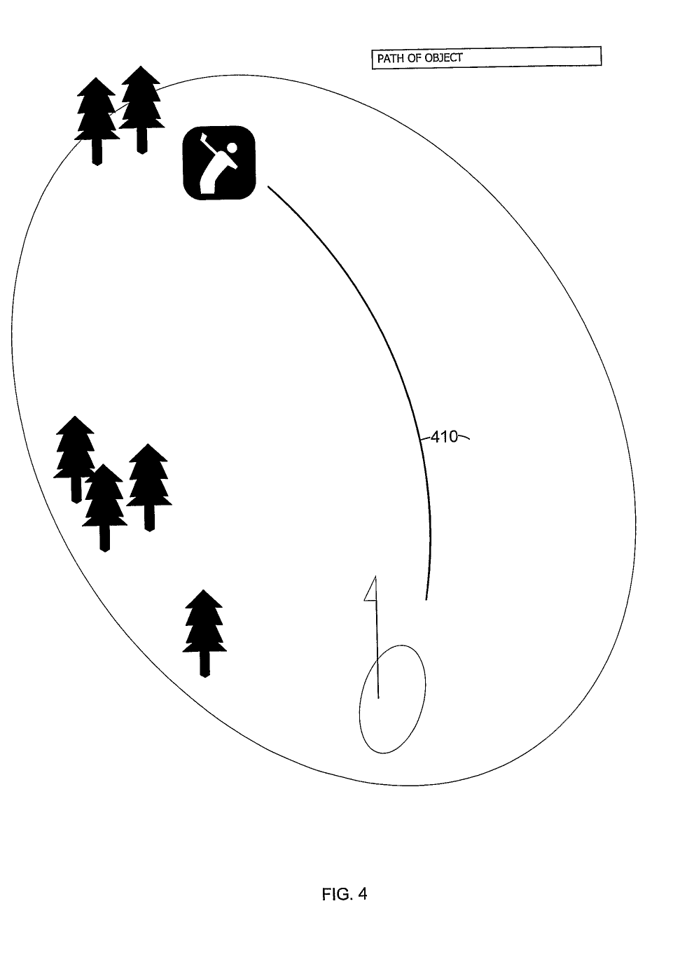

FIG. 4 depicts a plan view of the path taken by an object travelling over a surface.

In some implementations, it is preferred that the image capturing device for capturing a moving image of the moving object as it travels over a surface such as golf course 120 be a hand-held device incorporating a camera such as a mobile telephone with a digital camera. Thus, for example, a third party can record the moving image with his mobile telephone's video recording capabilities. As mentioned above, the handheld device should advantageously be capable of recording time code with the captured moving image, so as to record the absolute or relative time at which the moving object is present at each position in the captured moving image.

In some implementations, it is preferred that the position recording device for recording the geographical position of the location at which the moving image is captured be a GPS receiver.

Alternatively, the position recording device for recording the geographical position of the location at which the moving image is captured may be a mobile telephone equipped with GPS functionality.

In some implementations, the position recording device for recording the geographical position of the location at which the moving image is captured may be one or more stationary cameras. Thus, where the movement of the ball over the green is captured using one or more stationary cameras, for example where a golf tournament is being televised, the position and orientation of the one or more cameras relative to the putting green may be used to correlate the image acquired by the one or more cameras with a digitised map of the green.

In some implementations, it is preferred that the data acquiring device for obtaining a digitised map of said location based on geographical position includes contour information of the surface. In some implementations, the data acquiring device would comprise online geographic information system (GIS) data.

In some implementations, it is preferred that the processor for processing the captured moving image to generate image information for allowing the image to be correlated with the digitised map include image information defining the surface of the putting green. The image information defining the surface of the putting green may be obtained by a GPS receiver.

In some implementations, to provide displaying capabilities, the subject matter described herein may be implemented on a device having a display (e.g., a CRT (cathode ray tube) or LCD (liquid crystal display) monitor) or other visual interface for displaying information to the user and a method by which the user may provide input to the computing system and observe the display.

In some implementations, it is preferred that the moving object 111 is a golf ball and the surface 120 is a putting green.

The subject matter described herein may be implemented in an information processing system such as a computing system that includes a back-end component (e.g., a data server), or that includes a front-end component (e.g., a client computer having a graphical user interface, a mobile telephone or a Web browser through which a user may interact with an implementation of the subject matter described herein), or any combination of such back-end or front-end components.

In some implementations, the computing system may be configured, e.g., by means of appropriate software, to determine from the position of the object moving over the surface and the associated time code the instantaneous velocity of the object. For instance, by correlating the captured moving image with the map to determine the path of the moving object over the surface in three dimensions, the instantaneous velocity of the object as it moves along the path can be determined by reference to the recorded absolute or relative time at which the moving object is at each position. Such instantaneous velocity may be calculated, for example, by differentiating the information defining the position of the moving object on the path with respect to time.

Similarly, the acceleration (or ‘drive’) of the moving object may be calculated by the computing system by differentiating such instantaneous velocity information.

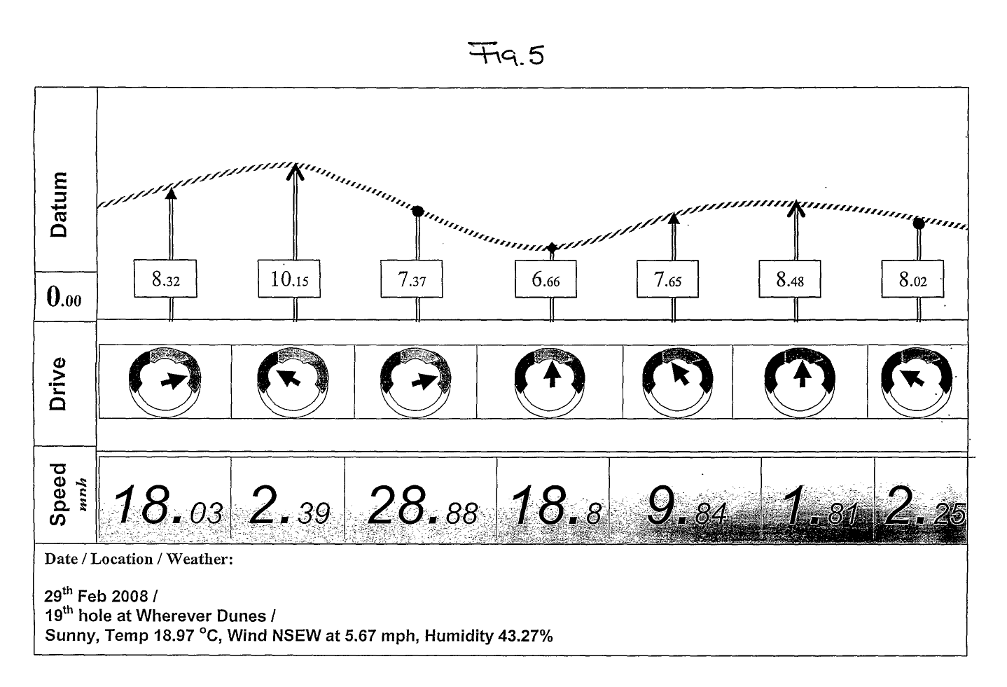

As mentioned above, the information about the path taken by the moving object over the surface may be displayed to a user graphically, e.g., on a suitable monitor. Such information may include, as illustrated in FIG. 5, the profile of the path taken by the object in two dimensions, including optionally the height of the path relative to an arbitrary datum, as well as the instantaneous speed and/or acceleration (‘drive’) of the object.

The foregoing description is intended to illustrate but not to limit the scope of the invention, which is defined by the scope of the appended claims. Other embodiments are within the scope of the following claims.

1. A method of generating a profile of the path taken by an object travelling on a 3-dimensional surface at a location, said method comprising:
(i) obtaining a digitised map of said location, said map comprising contour information defining contours of said surface;
(ii) capturing a moving image of said object as it travels on the surface;
(iii) obtaining information allowing the captured image to be correlated with said map and thereafter performing such correlation; and
(iv) using said correlation, processing said captured moving image to generate information defining the actual path taken by the object over said surface as defined by the map.

2. A method as claimed in claim 1, characterised by processing said captured moving image to generate said information for allowing the image to be correlated with said map.

3. A method as claimed in claim 2, characterised in that said information for allowing the image to be correlated with said map comprises information defining said surface.

4. A method as claimed in claim 2, characterised by obtaining positional information defining the position at which said moving image is captured and using that positional information to obtain said digitised map of the location.

5. A method as claimed in claim 4, wherein said positional information comprises global navigation satellite system (e.g., GPS), online geographic information system (GIS) or other comparable positional technology data.

6. A method as claimed in claim 1, characterised in that said information for allowing the image to be correlated with said map comprises information defining the position and orientation relative to the surface at which said moving image is captured.

7. A method as claimed in claim 1, characterised in that said moving image includes time information defining the time at which each frame or instant the moving image is captured.

8. A method as claimed in claim 7, characterised by calculating from said information defining the path and said time information the instantaneous velocity of the object.

9. A method as claimed in claim 7, characterised by using the information defining the path and said time information to calculate the instantaneous acceleration of the object.

10. A method as claimed in claim 1, characterised by displaying said profile.

11. A method as claimed in claim 1, characterised in that said surface is a putting green and said object is a golf ball.

12. Apparatus for generating a profile of the path taken by an object travelling over a 3-dimensional surface at a location, said apparatus comprising:
(i) an image-capturing device for capturing a moving image of said object as it travels over said surface;
(ii) a data-acquiring device for obtaining a digitised map of said location, said map comprising contour information defining contours of said surface, and information for allowing the captured image to be correlated with said map; and
(iii) information processing means for correlating said captured moving image with said map and processing said captured moving image using said correlation to generate information defining the path taken by the object over said surface as defined by the map.

13. Apparatus as claimed in claim 12, characterised in that said information for allowing the image to be correlated with said map comprises information defining the position and orientation relative to the surface at which said moving image is captured.

14. Apparatus for generating a profile of the path taken by an object travelling over a 3-dimensional surface at a location, said apparatus comprising:
(i) an image-capturing device for capturing a moving image of said object as it travels over said surface;
(ii) a position recording device for recording the geographical position of the location at which said moving image is captured;
(iii) a data-acquiring device for obtaining a digitised map of said location based on said geographical position, said map comprising contour information defining contours of said surface; and
(iv) information processing means for processing said captured moving image to generate image information for allowing the image to be correlated with said map, using said image information to correlate said captured moving image with said map and processing said captured moving image using said correlation to generate information defining the path taken by the object over said surface as defined by the map.

15. Apparatus as claimed in claim 14, characterised in that said image information comprises information defining said surface.

16. Apparatus as claimed in claim 14, wherein said positional information comprises global navigation satellite system (e.g., GPS), online geographic information system (GIS) or other comparable positional technology data.

17. Apparatus as claimed in claim 12, wherein said moving image comprises time information defining the time at which each frame or instant of the moving image is captured.

18. Apparatus as claimed in claim 17, wherein said information processing means are configured to calculate from said information defining the path and said time information the instantaneous velocity of the object.

19. Apparatus as claimed in claim 17, wherein said information processing means are configured to calculate from said information defining the path and said time information the instantaneous acceleration of the object.

20. Apparatus as claimed in claim 12, characterised by displaying said profile.

21. Apparatus as claimed in claim 12, characterised by enabling said profile.

22. A computing system implemented method of generating a profile of a path over a 3-dimensional surface taken by an object at a location, the method comprising:
correlating digital map information of the location with moving image information captured of the object in a path over the 3-dimensional surface of the location to generate a correlation between the object and the surface, the digital map information including contour information defining a contour of the 3-dimensional surface; and
generating path information of the path over the 3-dimensional surface taken by the object based on the correlation.

23. The computing system implemented method in accordance with claim 22, wherein the digital map information is associated with positional information defining a geographic position at which the moving image information of the object is captured.

24. The computing system implemented method in accordance with claim 23, wherein the positional information includes global navigation satellite system data or online geographic information system data.

25. The computing system implemented method in accordance with claim 22, wherein the correlating further includes defining a position and an orientation of the object relative to the surface.

26. The computing system implemented method in accordance with claim 22, wherein the moving image information includes a plurality of frames of a moving image, each frame of the plurality of frames including time information defining the time at which the frame is captured.

27. The computing system implemented method in accordance with claim 22, further comprising calculating a velocity of the object based on the path information.

28. The computing system implemented method in accordance with claim 22, further comprising generating a display of the profile of the path over the 3-dimensional surface.

29. The computing system implemented method in accordance with claim 22, wherein the surface is a putting green, and the object is a golf ball.

30. A computer program product, embodied in instruction code stored on a machine-readable medium, for generating a profile of a path over a 3-dimensional surface taken by an object at a location, the instruction code including instructions that cause a computing system to:
correlate digital map information of the location with moving image information captured of the object in a path over the surface of the location to generate a correlation between the object and the surface, the digital map information including contour information defining a contour of the 3-dimensional surface; and
generate path information of the path over the 3-dimensional surface taken by the object based on the correlation.

31. The computer program product in accordance with claim 30, wherein the digital map information is associated with positional information defining a geographic position at which the moving image information of the object is captured.

32. The computer program product in accordance with claim 31, wherein the positional information includes global navigation satellite system data or online geographic information system data.

33. The computer program product in accordance with claim 30, wherein the instruction code further includes instructions to define a position and an orientation of the object relative to the surface.

34. The computer program product in accordance with claim 30, wherein the moving image information includes a plurality of frames of a moving image, each frame of the plurality of frames including time information defining the time at which the frame is captured.

35. The computer program product in accordance with claim 30, wherein the instruction code further includes instructions to calculate a velocity of the object based on the path information.

36. The computer program product in accordance with claim 30, wherein the instruction code further includes instructions to generate a display of the profile of the path over the 3-dimensional surface.

37. The computer program product in accordance with claim 30, wherein the surface is a putting green, and the object is a golf ball.

38. A computing system for generating a profile of a path over a 3-dimensional surface taken by an object at a location,
the computing system being configured to:
correlate digital map information of the location with moving image information captured of the object in a path over the surface of the location to generate a correlation between the object and the surface, the digital map information including contour information defining a contour of the 3-dimensional surface; and
generate path information of the path over the 3-dimensional surface taken by the object based on the correlation.

39. A computing system implemented method of generating a profile of a path over a 3-dimensional surface taken by an object at a location, the method comprising:
receiving in a computing system digital map information of the location, the digital map information including contour information defining a contour of the 3-dimensional surface;
receiving in the computing system moving image information captured of the object in a path over the surface of the location; correlating, using the computing system, the digital map information with the moving image information to generate a correlation between the object and the surface; and
generating, using the computing system, path information of the path over the 3-dimensional surface taken by the object based on the correlation.

40. A computing system implemented method comprising:
correlating digital map information of the location received from a data-acquiring device with moving image information captured by an image-capturing device of the object in a path over the 3-dimensional surface of the location to generate a correlation between the object and the surface, the digital map information including contour information defining a contour of the 3-dimensional surface;
generating path information of the path over the 3-dimensional surface taken by the object based on the correlation; and
determining the profile of the path over the 3-dimensional surface taken by the object based on the path information and the contour information.

41. A method according to claim 1, wherein the profile is 2-dimensional and wherein the method further comprises:
(v) from said contour information determining the profile of said path.

42. Apparatus according to claim 12, wherein the profile is 2-dimensional and the information processing means is further for determining the profile of said path from said contour information.

43. Apparatus according to claim 14, wherein the profile is 2-dimensional and the information processing means is further for determining the profile of said path from said contour information.

44. A computing system implemented method according to claim 22, wherein the profile is 2-dimensional, the method further comprising:
determining the 2-dimensional profile of the path over the 3-dimensional surface taken by the object based on the path information and the contour information.

45. A computer program product according to claim 30, wherein the profile is 2-dimensional and the instructions further cause the computer to:
determine the 2-dimensional profile of the path over the 3-dimensional surface taken by the object based on the path information and the contour information.

46. A computing system according to claim 38, wherein the profile is 2-dimensional and the computing system is further configured to:
determine the 2-dimensional profile of the path over the 3-dimensional surface taken by the object based on the path information and the contour information, and wherein the computing system further comprises a display to generate and output a display of the 2-dimensional profile of the path over the 3-dimensional surface.

47. A computing system according to claim 39, wherein the profile is 2-dimensional and the method further comprises:
determining, using the computing system, the 2-dimensional profile of the path over the 3-dimensional surface taken by the object based on the path information and the contour information.
